(19) United States
(12) Patent Application Publication
(10) Pub. No.: US 2012/0326534 A1
(43) Pub. Date: Dec. 27, 2012

(54) ELECTRICAL ACTUATORS WITH GROOVED TABLE TOP OR HOUSING

(76) Inventor: Alexei Stadnik, Beverly Hills, CA (US)

(21) Appl. No.: 13/335,204

(22) Filed: Dec. 22, 2011

Related U.S. Application Data
(60) Provisional application No. 61/460,265, filed on Dec. 28, 2010.

(51) Int. Cl. H02K 41/03; H02K 1/12

(52) U.S. Cl. 310/12.26; 310/216.002

(57) ABSTRACT

The invention provides electrical actuators with grooved table top or housing (grooved actuators). In the invented electrical actuators, the Eddy current losses in moving conductive part from stationary permanent magnets (or in stationary conductive part from moving magnets) are reduced due to grooves.

### BACKGROUND OF THE INVENTION

The problem of Eddy current losses in the electrical actuators is well known. Some way for solving the problem is described in “Design and Test of an Ironless, Three Degree-of-Freedom, Magnetically Levitated Linear Actuator with Moving Magnets” by J. V. Jansen, etc.—2005 IEEE International Conference on Electrical machines and Drives. For reduction of Eddy current losses the ceramic plate is used. The plate increase the distance between magnets and moving conductive part. This way is increasing actuator envelope. When using thick and strong magnets or go to high speed (several meter per second) the thickness of ceramic plate and therefore actuator envelope increase dramatically.

### DESCRIPTION OF THE FIGURES

FIG. 1.1—Linear actuator with linear flat electrical machine

FIG. 1.2—Linear actuator with linear flat electrical machine and grooved table top

FIG. 2—Grooved table top for linear actuators with linear flat electrical machine.

FIG. 3.1—Linear actuator with linear tubular electrical machine

FIG. 3.2—Linear actuator with linear tubular electrical machine and grooved housing

FIG. 4—Grooved housing for linear actuators with linear tubular electrical machine.

FIG. 5.1—Rotary actuator with rotary radial (magnets inside) ironless electrical machine

FIG. 5.2—Rotary actuator with rotary radial (magnets inside) ironless electrical machine and grooved housing

FIG. 6—Grooved housing for rotary actuators with rotary radial (magnets inside) ironless electrical machine

FIG. 7.1—Rotary actuator with rotary radial (magnets outside) ironless electrical machine

FIG. 7.2—Rotary actuator with rotary radial (magnets outside) ironless electrical machine and grooved housing

FIG. 8—Grooved housing for rotary actuators with rotary radial (magnets outside) ironless electrical machine

FIG. 9.1—Rotary actuator with rotary axial ironless electrical machine

FIG. 9.2—Rotary actuator with rotary axial ironless electrical machine and grooved housing

FIG. 10—Grooved housing for rotary actuators with rotary axial ironless electrical machine

### DRAWINGS—REFERENCE NUMERALS

12—forcer (linear flat actuator)

14—table top (linear flat actuator)

16—magnet track (linear flat actuator)

22—linear bearings (linear flat actuator)

24—actuator base (linear flat actuator)

26—grooved table top (linear flat actuator)

28—grooves (linear flat actuator)

32—forcer (linear tubular actuator)

34—actuator housing (linear tubular actuator)

36—magnet track (linear tubular actuator)

38—magnets (linear tubular actuator)

40—tube (linear tubular actuator)

42—linear bearings (linear tubular actuator)

44—grooved housing (linear tubular actuator)

46—grooves (linear tubular actuator)

48—stator (rotary actuator, radial, magnets inside)

50—rotor (rotary actuator, radial, magnets inside)

52—table top (rotary actuator, radial, magnets inside)

54—magnets (rotary actuator, radial, magnets inside)

56—bushing (rotary actuator, radial, magnets inside)

58—bearings (rotary actuator, radial, magnets inside)

60—coils (rotary actuator, radial)

62—epoxy

64—housing (rotary actuator, radial, magnets inside)

66—stator with grooved housing (rotary actuator, radial, magnets inside)

68—grooved housing (rotary actuator, radial, magnets inside)

70—grooves (rotary actuator, radial, magnets inside)

72—stator (rotary actuator, radial, magnets outside)

74—rotor (rotary actuator, radial, magnets outside)

76—table top (rotary actuator, radial, magnets outside)

78—magnets (rotary actuator, radial, magnets outside)

80—bushing (rotary actuator, radial, magnets outside)

82—bearings (rotary actuator, radial, magnets outside)

83—housing (rotary actuator, radial, magnets outside)

84—stator with grooved housing (rotary actuator, radial, magnets outside)

86—grooved housing (rotary actuator, radial, magnets outside)

88—grooves (rotary actuator, radial, magnets outside)

90—stator (rotary actuator, axial)

92—rotor (rotary actuator, axial)

94—table top (rotary actuator, axial)

96—magnets (rotary actuator, axial)

98—bearings (rotary actuator, axial)

100—coils (rotary actuator, axial)

102—housing (rotary actuator, axial)

104—stator with grooved housing (rotary actuator, axial)

106—grooved housing (rotary actuator, axial)

108—grooves (rotary actuator, axial)

### DESCRIPTION OF THE PREFERRED EMBODIMENT

Linear Actuator with Linear Flat Electrical Machine.

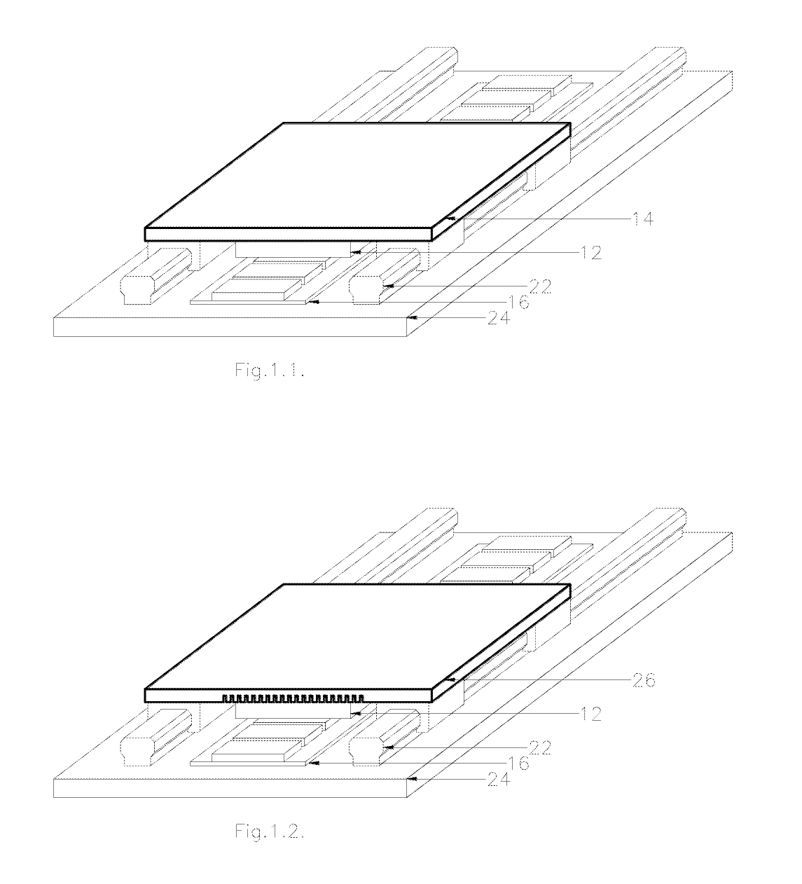

Linear actuator with linear flat electrical machine is shown on FIG. 1.1. Actuator consists of forcer 12, mounted to the table top 14 (usually made of conductive material, for example, aluminum), and magnet track 16. Table top is mounted to linear bearings 22. Linear bearings and magnetic plate are installed on the actuator base 24. During machine moving the Eddy current losses will occur in the table top.

The construction of the invented linear electric actuator with linear flat electrical machine includes forcer 12 mounted to the grooved table top 26 (FIG. 1.2). Grooves prevent Eddy current losses in the table top.

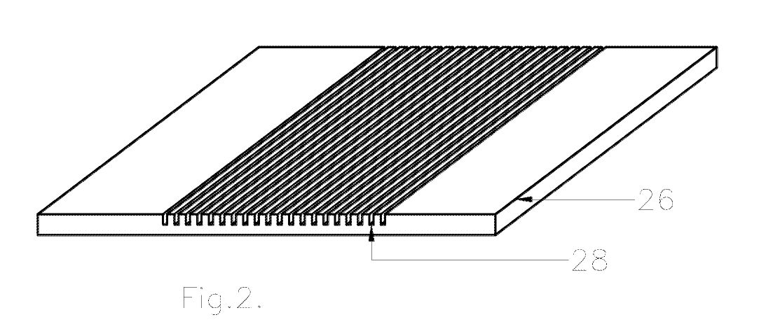

The grooved table top 26 for linear actuator with linear flat electrical machine is shown on FIG. 2. It is made of solid non-ferromagnetic or ferromagnetic material or compound. Grooves 28 are made along the table top length (parallel to electrical machine moving direction) or other direction. The exact dimensions, direction and quantity of grooves depend on electromechanical design and are subject for optimization.

Linear Actuator with Linear Tubular Electrical Machine.

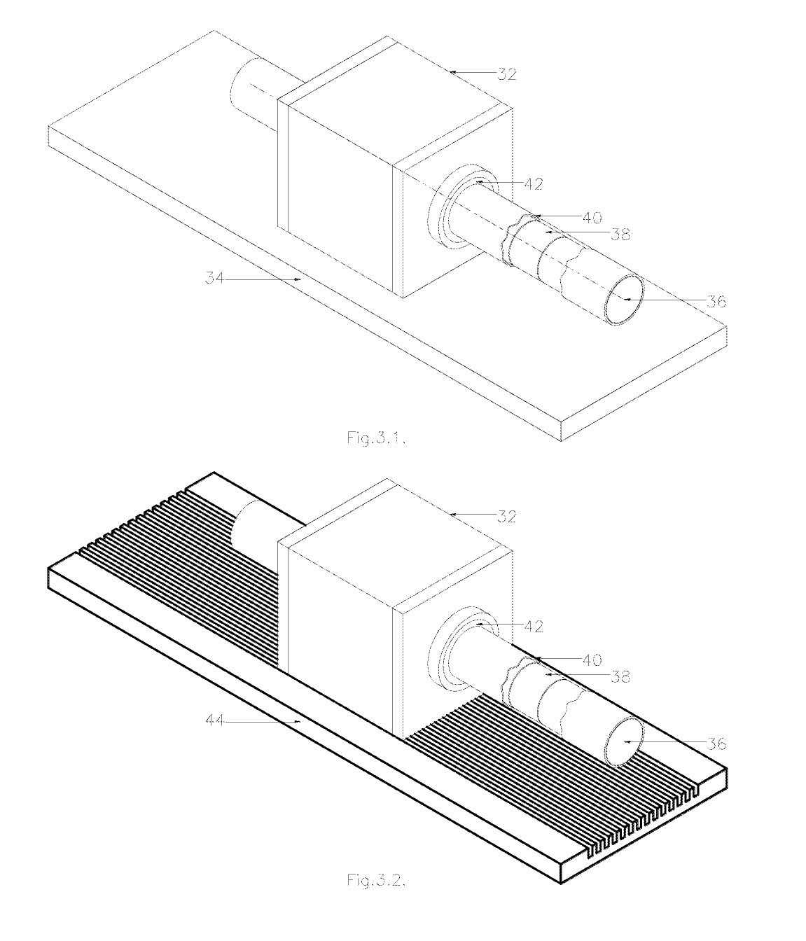

Linear actuator with linear tubular electrical machine is shown on FIG. 3.1. Actuator consists of forcer 32, mounted to the actuator housing 34 (usually made of conductive material, for example, aluminum), and magnet track 36. Magnet track 36 consists of magnets 38 placed inside tube 40. Magnet track is supported by linear bearings 42. During machine moving the Eddy current losses will occur in the actuator housing.

The construction of the invented linear electric actuator with linear tubular electrical machine includes forcer 32 mounted to the grooved actuator housing 44 (FIG. 3.2). Grooves prevent Eddy current losses in the actuator housing.

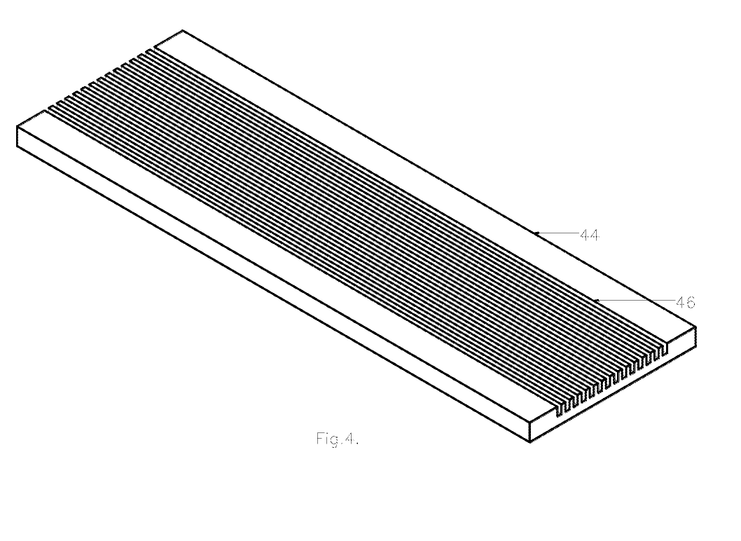

The grooved housing 44 for linear actuator with linear flat electrical machine is shown on FIG. 4. It is made of solid non-ferromagnetic or ferromagnetic material or compound. Grooves 46 are made along the housing length (parallel to electrical machine moving direction) or other direction. The exact dimensions, direction and quantity of grooves depend on electromechanical design and are subject for optimization.

Rotary Actuator with Rotary Radial (Magnets Inside) Ironless Electrical Machine.

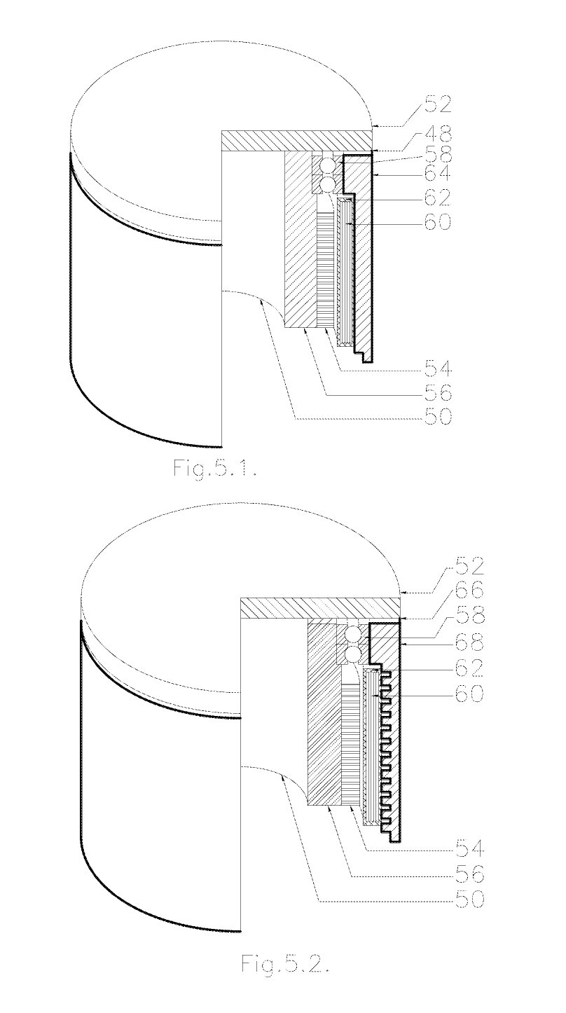

Rotary actuator with rotary radial (magnets inside) ironless electrical machine is shown on FIG. 5.1. Actuator consists of stator 48 and rotor 50, mounted to the table top 52. Rotor consists of magnets 54 and bushing 56. Table top is mounted to bearings 58. Stator 48 consists of coils 60, encapsulated in epoxy 62 and mounted to the housing 64 (usually made of conductive material, for example, aluminum). During machine moving the Eddy current losses will occur in the housing.

The construction of the invented rotary electric actuator with rotary radial (magnets inside) ironless electrical machine includes stator 66 that consists of coils 60, encapsulated in epoxy 62 and mounted to the grooved housing 68 (FIG. 5.2). Grooves prevent Eddy current losses in the housing.

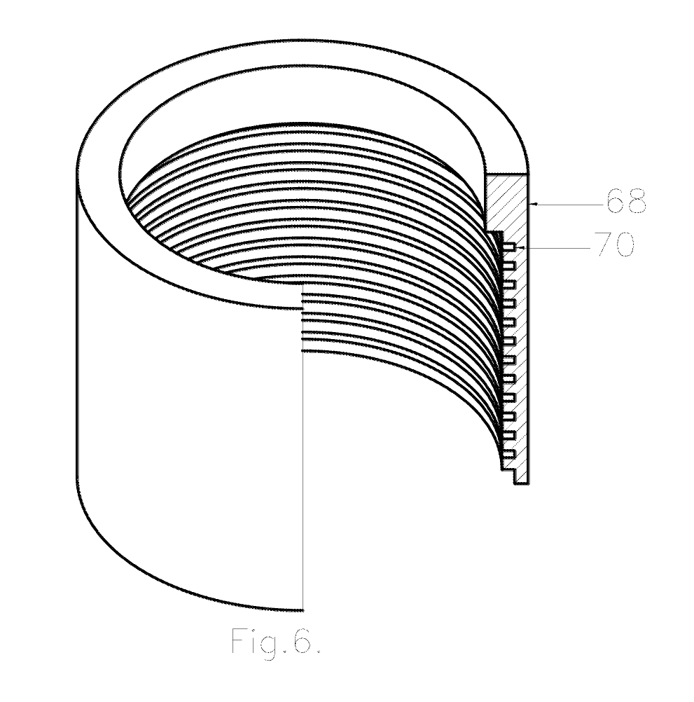

The grooved housing 68 for rotary actuator with rotary radial (magnets inside) ironless electrical machine is shown on FIG. 6. It is made of solid non-ferromagnetic or ferromagnetic material or compound.

Grooves 70 are made perpendicular the rotation axis (parallel to electrical machine rotation), corkscrew direction, spiral direction or other direction. The exact dimensions, direction and quantity of grooves depend on electromechanical design and are subject for optimization.

Rotary Actuator with Rotary Radial (Magnets Outside) Ironless Electrical Machine.

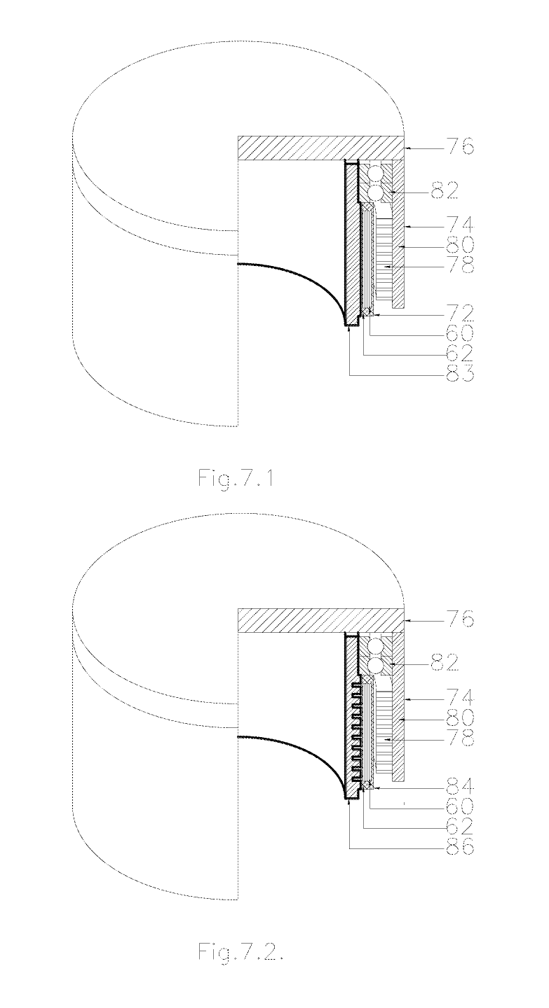

Rotary actuator with rotary radial (magnets outside) ironless electrical machine is shown on FIG. 7.1. Actuator consists of stator 72 and rotor 74, mounted to the table top 76. Rotor consists of magnets 78 and bushing 80. Table top is mounted to bearings 82. Stator 72 consists of coils 60, encapsulated in epoxy 62 and mounted to the housing 83 (usually made of conductive material, for example, aluminum). During machine moving the Eddy current losses will occur in the housing.

The construction of the invented rotary electric actuator with rotary radial (magnets outside) ironless electrical machine includes stator 84 that consists of coils 60, encapsulated in epoxy 62 and mounted to the grooved housing 86 (FIG. 7.2). Grooves prevent Eddy current losses in the housing.

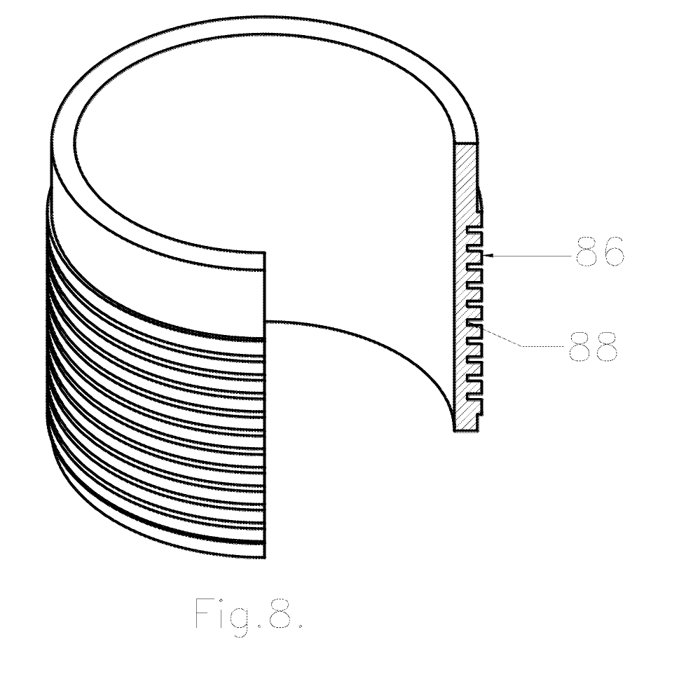

The grooved housing 86 for rotary actuator with rotary radial (magnets outside) ironless electrical machine is shown on FIG. 8. It is made of solid non-ferromagnetic or ferromagnetic material or compound.

Grooves 88 are made perpendicular the rotation axis (parallel to electrical machine rotation), corkscrew direction, spiral direction or other direction. The exact dimensions, direction and quantity of grooves depend on electromechanical design and are subject for optimization.

Rotary Actuator with Rotary Axial Ironless Electrical Machine.

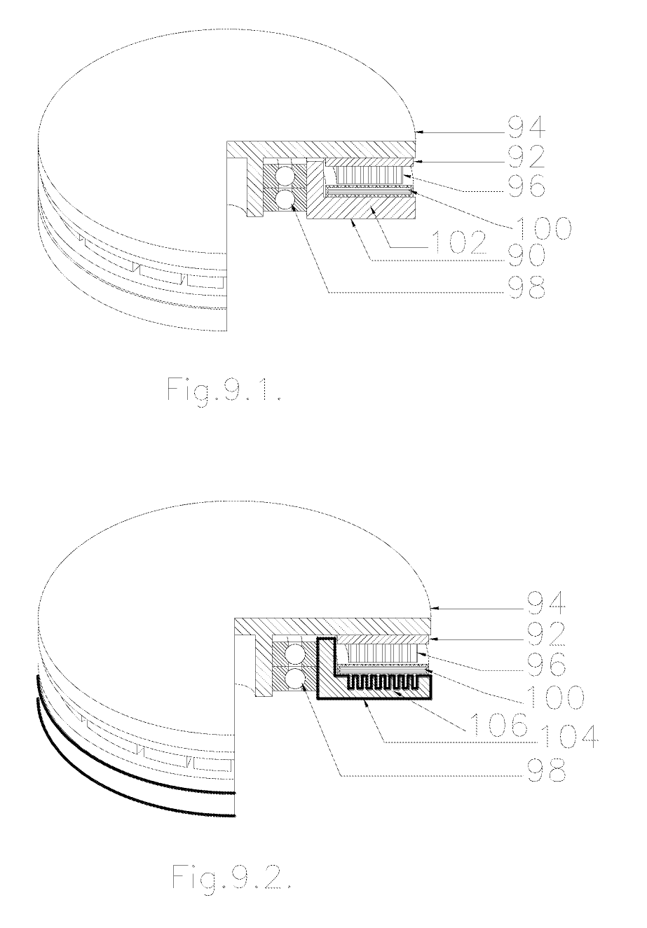

Rotary actuator with rotary axial ironless electrical machine is shown on FIG. 9.1. Actuator consists of stator 90 and rotor 92 with magnets 96, mounted to the table top 94. Table top is mounted to bearings 98. Stator 90 consists of coils 100, mounted to the housing 102 (usually made of conductive material, for example, aluminum). During machine moving the Eddy current losses will occur in the housing.

The construction of the invented rotary electric actuator with rotary axial ironless electrical machine includes stator 104 that consists of coils 100, mounted to the grooved housing 106 (FIG. 9.2). Grooves prevent Eddy current losses in the housing.

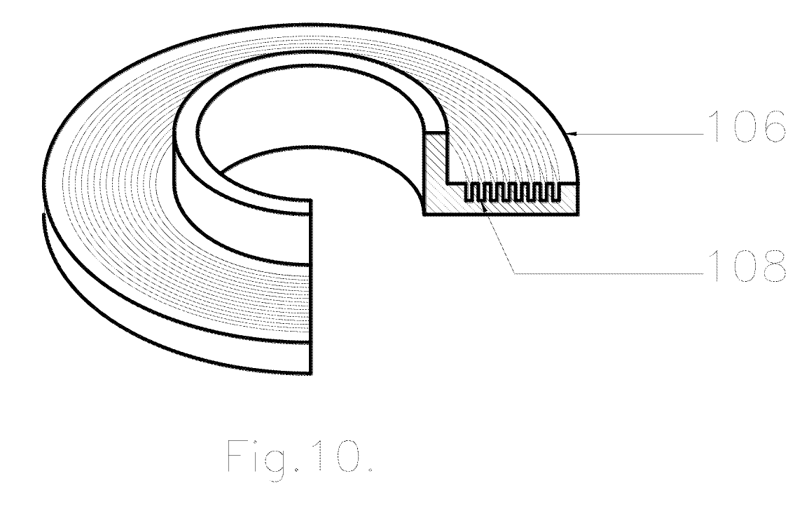

The grooved housing 106 for rotary actuator with rotary axial ironless electrical machine is shown on FIG. 10. It is made of solid non-ferromagnetic or ferromagnetic material or compound. Grooves 108 are made parallel to electrical machine rotation, corkscrew direction, spiral direction or other direction. The exact dimensions, direction and quantity of grooves depend on electromechanical design and are subject for optimization.

1. An electric actuator, comprising:
a) grooved table top or housing having a solid oriented or non-oriented, ferromagnetic or non-ferromagnetic material or compound,
b) grooves are made along the table top or housing length (parallel to electrical machine moving direction), perpendicular the rotation axis (parallel to electrical machine rotation), corkscrew direction, spiral direction or other direction.

2. A rotary actuator with rotary radial ironless (magnets inside or magnets outside) or axial ironless electrical machine, comprising:
a) grooved housing having a solid oriented or non-oriented, ferromagnetic or non-ferromagnetic material or compound,
b) grooves are made perpendicular the rotation axis (parallel to electrical machine rotation), corkscrew direction, spiral direction or other direction.

3. A linear actuator with linear flat or tubular electrical machine, comprising:
a) grooved table top or grooved housing a solid oriented or non-oriented, ferromagnetic or non-ferromagnetic material or compound,
b) grooves are made along the table top or housing length (parallel to electrical machine moving direction) or other direction.
